(19) United States
(12) Patent Application Publication
(10) Pub. No.: US 2010/0139806 A1
(43) Pub. Date: Jun. 10, 2010

(54) KIT, COMPRISING AN IMPROVED COMPRESSOR ASSEMBLY, FOR REPAIRING AND INFLATING INFLATABLE ARTICLES

(76) Inventor: Sergio Lolli, Pesaro (IT)

Correspondence Address: LADAS & PARRY LLP, 26 WEST 61ST STREET, NEW YORK, NY, 10023, US

(21) Appl. No.: 12/442,206

(22) PCT Filed: Sep. 21, 2007
(86) PCT No.: PCT/IB07/02736

§ 371 Date: Sep. 4, 2009

(30) Foreign Application Priority Data
Sep. 21, 2006 (IT) TO2006AOOO674

(51) Int. Cl. B65B 31/04; B67D 7/00; F04B 35/04; B29C 73/16

(52) U.S. Cl. 141/38; 222/4; 417/410.1

(57) ABSTRACT

A kit for repairing and inflating inflatable articles has a casing; a rotary compressor housed in the casing; a canister assembly containing sealing liquid for injection into an inflatable article; and fluidic connecting means for connecting the compressor to an inlet of the canister assembly.

### TECHNICAL FIELD

The present invention relates to a kit, comprising an improved compressor assembly, for repairing and inflating inflatable articles, in particular tyres.

### BACKGROUND ART

Tyre repair and inflation kits are known comprising an electrically powered compressor assembly, and a canister of sealing liquid which is injected, when necessary, into the tyre along a fluid line by compressed air from the compressor assembly.

More specifically, known compressor assemblies comprise an electric motor, and a reciprocating compressor powered by the electric motor. Reciprocating compressors, however, are normally noisy and comprise a relatively large number of component parts.

### DISCLOSURE OF INVENTION

It is an object of the present invention to provide a kit for repairing and inflating inflatable articles, designed to eliminate the aforementioned drawback.

According to the present invention, there is provided a kit for repairing and inflating inflatable articles, as claimed in Claim 1.

### BRIEF DESCRIPTION OF THE DRAWINGS

A preferred, non-limiting embodiment of the present invention will be described by way of example with reference to the accompanying drawings, in which:

FIG. 1 shows a schematic view in perspective of a kit for repairing and inflating inflatable articles in accordance with the present invention;

FIG. 2 shows a radial section of a compressor of the FIG. 1 kit.

### BEST MODE FOR CARRYING OUT THE INVENTION

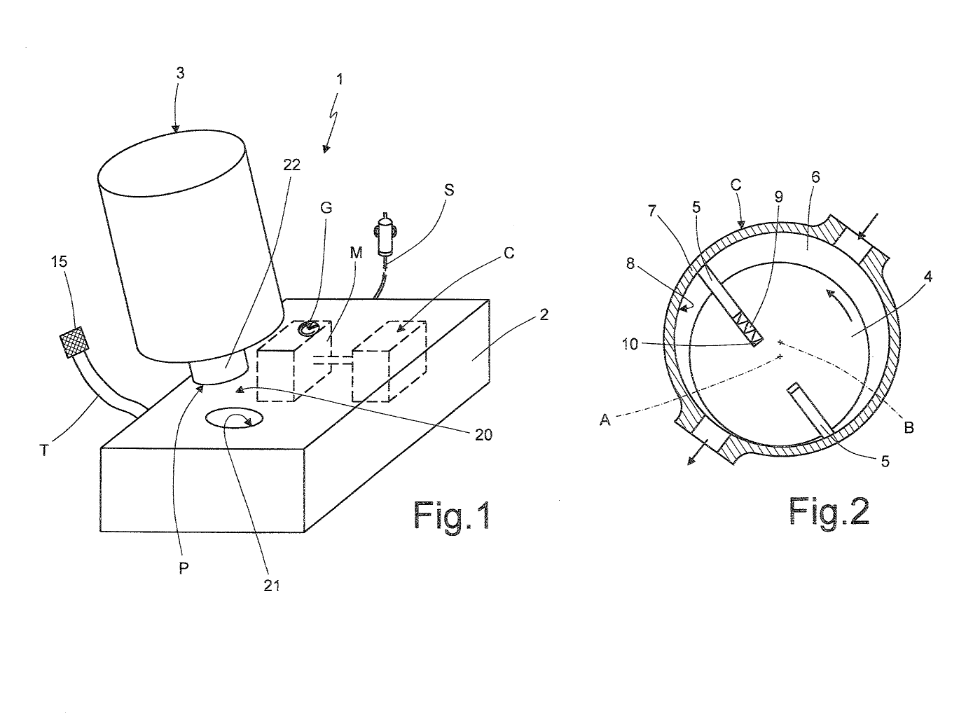

Number 1 in FIG. 1 indicates a kit for repairing and inflating inflatable articles, in particular tyres. Kit 1 substantially comprises a compressor assembly for producing compressed air; and a canister assembly 3 connected removably to the compressor assembly and containing a known sealing liquid for repairing punctures in tyres.

The compressor assembly comprises a boxlike casing 2; an electric motor M powered by means of a plug S and housed in casing 2; and a compressor C powered by the electric motor and also housed in casing 2.

An inlet P of canister assembly 3 is connected fluidically to compressor C by preferably releasable connecting means 20, e.g. a tube having a click-on or screw-on connecting portion connectable to canister assembly 3.

Connecting means 20 preferably define a seat 21 connected fluidically to compressor C, and comprise a connecting portion 22 of canister assembly 3 connectable mechanically and fluidically to seat 21.

Kit 1 also comprises a tube T for connecting canister assembly 3 fluidically to an inflatable article, e.g. a tyre, preferably by means of seat 21.

Compressor C (FIG. 2) is a rotary compressor, comprises a rotor 4 rotated by the electric motor about a fixed axis A, and is preferably a blade compressor, and so comprises at least one blade 5 rotated by rotor 4.

The rotor is housed inside a cylindrical chamber 6 defined by an outer casing 7 of compressor 2 and having an axis B.

Fixed axis A is parallel to and offset with respect to axis B, so that at least one variable-volume chamber is defined by rotor 4, by blade 5, and by an inner surface 8 of outer casing 7.

Each blade 5 is housed in sliding manner inside a radial seat 9 defined by rotor 4, and is held firmly against inner surface 8 by the radial force of an elastic member 10 housed in respective radial seat 9.

Electric motor M is conveniently connected to rotor 4 with a velocity ratio which reduces speed from electric motor M to rotor 4, and which is defined as the ratio of the speed of the output shaft of electric motor M to the speed of rotor 4.

The reduction velocity ratio is preferably less than 3, and more preferably less than 2.

For example, the velocity ratio is close to 1, and, in a preferred embodiment, electric motor M and rotor 4 are connected directly, i.e. with no intermediate gears, and with a velocity ratio of 1.

In actual use, canister assembly 3 is connected fluidically to compressor assembly C by releasable connecting means 20, and a ring nut 15 on tube T is screwed onto a valve of the tyre.

Plug S is plugged into a current outlet of the vehicle, and the electric motor is started by the user pressing a button G on casing 2.

The compressed air produced by compressor C flows through inlet P into canister assembly 3, and injects the sealing liquid into the tyre along tube T in known manner; and compressor C also provides for inflating the tyre once the puncture is sealed by the sealing liquid.

Kit 1 as described has the following advantages.

Being rotary, compressor C greatly reduces the operating noise level, by reducing mechanical vibration.

A blade compressor C comprises few component parts, and, for a given power of the electric motor, provides greater pressure and flow than a reciprocating compressor.

A blade compressor has better thermal efficiency and a better size-weight ratio than a reciprocating compressor.

With a relatively low speed of rotor 4, a blade compressor achieves the necessary flow and pressure to inject sealing liquid and inflate both automobile and industrial and/or heavy-duty vehicle tyres.

For repair and inflation purposes, a suitable rotation speed of rotor 4 has been found to range between 800 and 1300 rpm; in which conditions, the torque absorbed by a blade pump is low enough to permit low-reduction-ratio and, in some cases, even direct connection to the electric motor.

The lower rotation inertia and, hence, lower torque absorption of a rotary blade compressor also simplify startup.

Clearly, changes may be made to the repair and inflation kit compressor assembly as described and illustrated herein without, however, departing from the scope of the present invention as defined in the accompanying Claims.

In particular, the output shaft of the electric motor and rotor 4 may be connected in any manner. More specifically, fixed axis A may be parallel or crosswise to the output shaft of the electric motor.

The rotary compressor may be such that a moving member fitted with blades and defining at least one variable-volume chamber is driven by the electric motor along an endless, e.g. circular, trajectory about fixed axis A.

The seat in which each blade 5 is mounted in sliding manner may lie along a chord of rotor 4, as opposed to being radial.

Electric motor M may be connected to a resistive adjusting device, so that the speed of the output shaft of electric motor M is biuniquely defined by the value of a control resistor in the resistive adjusting device. To some extent, the same electric motor M may therefore be employed, and the speed of the output shaft of electric motor M be modified at the kit manufacturing stage, by changing the control resistor.

The control resistor of the resistive adjusting device may conveniently be short-circuited or bridged to adjust speed. For example, the bridge may be activated manually or electrically by a central control unit on the kit.

In another embodiment, tube T is connected to compressor C, and provides solely for inflating the inflatable article, and not repairing it with sealing liquid.

In which case, canister assembly 3 comprises a hose connected permanently to connecting portion 22, and which injects sealing liquid into the inflatable article and then feeds compressed air into the inflatable article, as described, for example, in the Applicant's Patent Application WO2005084968.

1) A kit for repairing and inflating inflatable articles, comprising a casing; an electric motor; a compressor driven by the electric motor and housed in said casing; a sealing liquid canister assembly; and fluidic connecting means for connecting said compressor to an inlet of said canister assembly; wherein said compressor is rotary.

2) A kit as claimed in claim 1, wherein said compressor is a blade compressor.

3) A kit as claimed in claim 1, wherein said electric motor is connected to said compressor with a reduction velocity ratio of less than 3.

4) A kit as claimed in claim 3, wherein said reduction velocity ratio is less than 2.

5) A kit as claimed in claim 4, wherein said electric motor is connected to said compressor with a velocity ratio of substantially 1.

6) A kit as claimed in claim 1, wherein said electric motor is connected directly to said compressor.

7) A kit as claimed in claim 1, wherein said compressor comprises a rotor rotating about a fixed axis.

8) A kit as claimed in claim 1, wherein said compressor comprises a rotary member defining an endless trajectory about said fixed axis.

9) A kit as claimed in claim 1, comprising a conduit connected to said compressor and connectable to said inflatable article.

10) A kit as claimed in claim 9, wherein said conduit is connected to said fluidic connecting means.

11) A kit as claimed in claim 1, wherein said electric motor comprises an electric-resistance device for adjusting rotation speed.

12) A kit as claimed in claim 11, wherein said rotation speed is adjusted by short-circuiting a control resistor of the electric-resistance device.
